(19) United States
(12) Patent Application Publication
(10) Pub. No.: US 2010/0134484 A1
(43) Pub. Date: Jun. 3, 2010

(54) THREE DIMENSIONAL JOURNALING ENVIRONMENT

(75) Inventors: Billy Chen, Bellevue, WA (US); Eyal Ofek, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/325,282

(22) Filed: Dec. 1, 2008

(51) Int. Cl. G06T 15/70; G06N 5/04; G06F 17/00; G06F 17/30

(52) U.S. Cl. 345/419; 706/58; 715/230

(57) ABSTRACT

A three-dimensional journaling system is described herein. The three-dimensional journaling system comprises a data repository that includes journal data of a user, wherein the journal data corresponds to at least one location in a geographic region. The system additionally includes a display component that causes at least a portion of the journal data to be displayed on a display screen as a journal entry in a computer-implemented three-dimensional representation of the geographic region at the location that corresponds to the journal data.

### BACKGROUND

Historically, people have felt the need to document and share activities in their lives. For instance, in prehistoric times individuals carved images and text on interiors of caves to document and share their activities. A most common and perhaps most traditional tool for documenting (e.g. journaling) one's activities is to write on paper using a writing instrument such as a pen. Many individuals with the ability to read and write have written diaries through use of pen and paper. Writing by hand, however, can take a significant amount of time when compared to typing. Additionally, a handwritten diary may be difficult to share with several others.

As personal computers have increased in popularity, tools for journaling have become more prevalent. For instance, a word processing application on a personal computer can be used in connection with typing one's activities over a period of time, thereby creating an electronic journal. As the Internet has become more popular as a means of communication, the number of digital journals has vastly increased. For example, web sites have been dedicated to web logs (blogs), which are typically short and used for journaling, commentary, catharsis, muse, etc. As blogs are essentially web pages, they are widely accessible, thereby allowing journals in the form of blogs to be shared amongst friends easily. Even quickly typing a blog, however, can be time consuming as it may be difficult to describe one's activities in text.

### SUMMARY

The following is a brief summary of subject matter that is described in greater detail herein. This summary is not intended to be limiting as to the scope of the claims.

Described herein are various technologies pertaining to journaling in general and, more particularly, to a three-dimensional journaling environment. Pursuant to an example, a three-dimensional representation of a geographic region can be used as a backdrop for journaling one's activities. For instance, journal data of a user can be represented in the three-dimensional representation of the geographic region as a journal entry, wherein the journal data corresponds to a particular location in the geographic region. Therefore, an individual reviewing the journal entry can quickly ascertain at least some context pertaining to the journal entry. The journal data and/or journal entry can be or include a textual entry, one or more pictures, video, audio, hyperlinks, GPS traces, amongst other data.

An individual that is creating a journal in the three-dimensional representation of the geographic region can submit the journal data and annotate the journal data in a variety of manners in connection with creating and/or updating a journal entry. For instance, the individual may have taken several photographs through use of a digital camera, wherein the digital camera may be a GPS enabled camera and therefore the photographs can be tagged with geoposition of the individual at the time the photographs were taken. The photographs can then be automatically embedded into the three-dimensional representation of the geographic region at the location indicated in the tags of the photographs. In another example, the individual can manually direct journal data to a particular location in the three-dimensional representation of the geographic region.

The individual may then choose to publish a journal entry based upon the journal data such that others can review the journal entry. Indicia can be displayed in the three-dimensional representation such that reviewers of the journal entry can quickly ascertain type of journal entry (e.g., photograph, text, . . . ) and review such journal entry in the context of a three-dimensional environment. Furthermore, the reviewer may zoom in or zoom out, rotate views, change a viewing perspective, etc. in the three-dimensional environment to obtain additional context with respect to journal entries. Still further, an avatar can be graphically rendered to represent a particular action in a three-dimensional environment. For instance, an avatar can be rendered as sitting on a sofa, watching television, walking in a particular region, etc. In another example, a reviewer can access a journal entry through a mobile device when travelling with the mobile device. For instance, the reviewer can be provided with notifications when the reviewer is proximate to a location that corresponds to a journal entry.

Other aspects will be appreciated upon reading and understanding the attached figures and description.

### BRIEF DESCRIPTION OF THE DRAWINGS

FIG. 1 is a functional block diagram of an example system that facilitates displaying journal data in a three-dimensional representation of a geographic region.

FIG. 2 is a functional block diagram of an example system that facilitates inferring transition states between journaled events.

FIG. 3 is an example depiction of a component that facilitates displaying journal data in a three-dimensional representation of a geographic region.

FIG. 4 is a functional block diagram of an example system that facilitates analyzing journal data.

FIG. 5 is a flow diagram that illustrates an example methodology for displaying journal data of a user in a three-dimensional representation of a geographic region.

FIG. 6 is a flow diagram that illustrates an example methodology for animating an avatar to represent transition of a user in a three-dimensional representation of a geographic region.

FIG. 7 is a flow diagram that illustrates an example methodology for providing an indication that a user is proximate to a journaled event of another user.

FIG. 8 is a flow diagram that illustrates an example methodology for simultaneously displaying journal data of separate users in a three-dimensional representation of a geographic region.

FIG. 9 is a flow diagram that illustrates an example methodology for animating an avatar in a three-dimensional representation of a geographic region.

FIG. 10 is an example computer implemented three-dimensional representation of a geographic region.

FIG. 11 is an example computer implemented three-dimensional representation of a geographic region.

FIG. 12 illustrates an example geographic trace.

FIG. 13 is an example graphical user interface that facilitates annotating journal data.

FIG. 14 is an example computing system.

### DETAILED DESCRIPTION

Various technologies pertaining to journaling will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

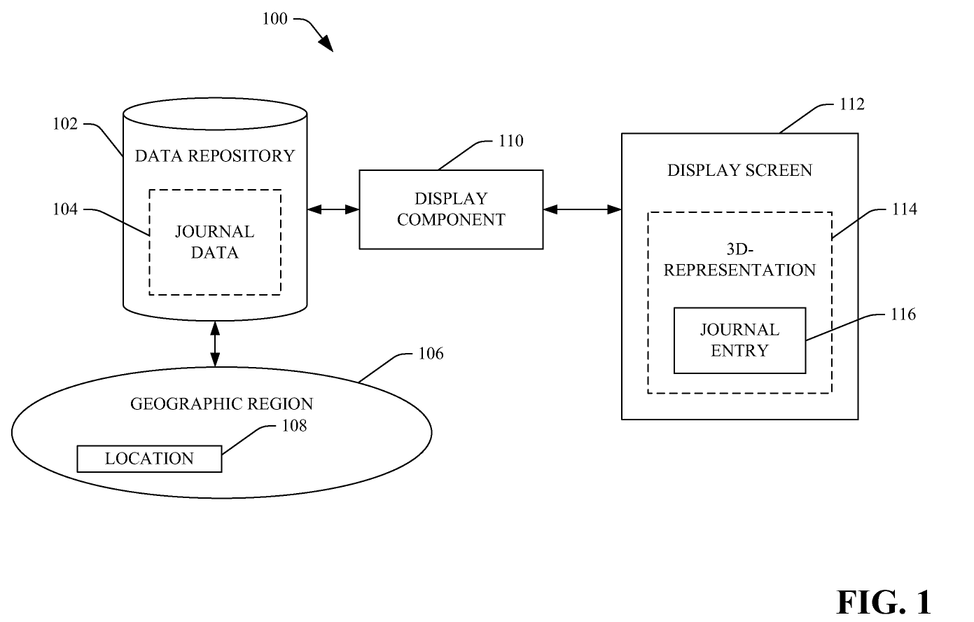

With reference to FIG. 1, an example system 100 that facilitates journaling in connection with a three-dimensional representation of a geographic region is illustrated. The system 100 includes a data repository 102 that comprises journal data 104 of a user. The journal data 104 can be or include data such as a global positioning system trace, a picture, a video, text, audio, a hyperlink, etc. Further, the journal data may pertain to a certain location or locations in a geographic region, and may further pertain to an activity of the user, commentary of the user, an event in the user's life, etc. The journal data 104 can generally correspond to a geographic region 106 and can more particularly correspond to a specific location 108 in the geographic region 106. For example, the geographic region 106 can be the world, a country, a state, a city, one or more city blocks, a particular building, a residence, etc. Accordingly, the location 108 can be a country, a state, a city, one or more city blocks, a building, a residence, a particular location in a building, etc. Therefore, for instance, the journal data 104 can be a picture of a building. The geographic region 106 can be a city block and the location 108 may be a location proximate to the building.

The system 100 can additionally include a display component 110 that causes at least a portion of the journal data 104 to be displayed as a journal entry 116 on a display screen 112 in a computer implemented three-dimensional representation 114 of the geographic region 106. Thus, a journal entry can be a representation of at least a portion of the journal data 104 in the three-dimensional representation 114 of the geographic region 106. The journal entry 116 can be or include text, a photograph, a video, an icon, a hyperlink, some combination thereof, etc. A three-dimensional representation that includes at least one journal entry of a user can be referred to herein as a three-dimensional journal.

The display component 110 can cause the journal entry 116 to be displayed at a location in the three-dimensional representation 114 that corresponds to location 108 in a geographic region 106. As will be described in greater detail herein, the user can choose to share the journal entry 116 with other users (e.g., contacts of the user) such that other users can browse the three-dimensional representation 114 to view the journal entry 116 and other journal entries of the user.

User input of journal data to a three-dimensional journaling system will now be briefly described. The journal data 104 can be input to the data repository 102 in any suitable manner. For instance, the journal data 104 can be imported directly from a mobile device into the data repository 102 (and thus directly into the three-dimensional representation 114 as a journal entry). In another example, the journal data 104 can be provided from a desktop computer, a laptop or other specialized hardware such as a camera configured with networking and GPS capabilities. Pursuant to an example, the data repository 102 may reside on a dedicated server. Accordingly, if the user employs a personal computer or laptop the user can upload the journal data 104 to data repository 102 by way of the Internet. In another example, if the user chooses to upload the journal data 104 to the data repository 102 using a portable device, such journal data 104 can be uploaded to the data repository 102 through SMS, MMS, e-mail and Internet connections, etc.

Representation of journal data as one or more journal entries will now be briefly described. The display component 110 can employ any suitable representation technologies in connection with displaying journal entries in the three-dimensional representation 114. For instance, a display component 110 can use a markup language to in connection with representing the journal data 104 as the journal entry 116 in the three-dimensional representation 114. Example markup languages that can be employed by the display component 110 include HTML, XML and KML. KML allows for media to be geocoded into position and orientation. Furthermore, the display component 110 can analyze metatags specific to particular media in connection with displaying the journal entry 116 in the three-dimensional representation 114. Example metatags specific to particular media include focal link and standoff distance for photographs.

Furthermore, the display component 110 can geocode the journal data 104 such that a journal entry based on the journal data is oriented in a desired manner in the three-dimensional representation 114. Geocoding can be performed automatically by specialized hardware or manually through interactive software. For instance, mobile devices equipped with GPS, a compass and/or an accelerometer can automatically geocode the media, text, etc. If such specialized hardware is not available or the journal data 104 originates at a different location, the user can use interactive geopositioning software to orient the journal data 104 such that a corresponding journal entry is represented as desired in the three-dimensional representation 114. As will be described in greater detail below, the journal data 104 can be enriched automatically and/or by the user with additional details. For instance, transition states between journal entries (e.g., events in the journal data 104) can be automatically inferred. In another example, the user can select at least a portion of the journal data 104 and manually provide additional details pertaining to the journal data 104. For instance, the journal data 104 may include geographic data that indicates that the user was at a particular location for a certain period of time. The user can select such journal data 104 and indicate what the user was undertaking at the geographic location (e.g., eating, working . . . ).

Moreover, as will be described in greater detail below, journal entries can be shared with others at the discretion of the user. An individual reviewing journal data of the user can browse by location such that the reviewer is provided with journal entries of the user that pertain to a particular geographic region. In another example, the reviewer can browse the journal data by time such that journal entries in a specified time period are presented to the reviewer. In such an example, the display component 110 can cause the three-dimensional representation to include locations pertaining to journal entries that correspond to the specified time period.

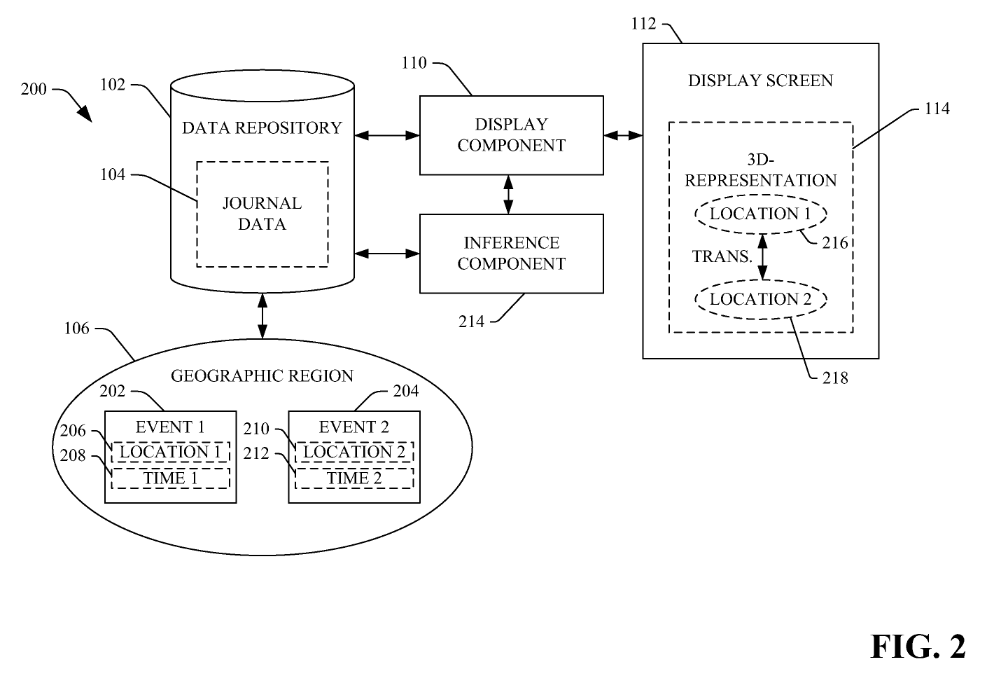

Referring now to FIG. 2, an example system 200 that facilitates inferring transition states between events in the journal data 104 is illustrated. The system 200 includes the data repository 102 which retains the journal data 104. In an example, the journal data 104 can include data pertaining to two separate events, wherein an event can be any suitable activity undertaken by the user such as eating dinner, eating lunch, reading a book, watching television, etc. More particularly, the journal data 104 can include data that is representative of a first event 202 and a second event 204, wherein the first event 202 corresponds to a first location 206 in the geographic region 106 and a first time 208 and the second event 204 corresponds to a second location 210 in the geographic region 106 and a second time 212.

The system 200 can additionally include an inference component 214 that can infer a transition between the first event 202 and the second event 204 based at least in part upon the first location 206, the first time 208, the second location 210 and the second time 212. For instance, the first event 202 can pertain to the user eating breakfast in San Francisco and the second event 204 can pertain to the user eating dinner in New York. Accordingly, the inference component 214 can infer that the user traveled via plane from San Francisco to New York. Similarly, for more local events the inference component 214 can infer if the user walked, jogged, drove or used other suitable transportation between events in the journal data 104. In a detailed example, the inference component 214 can, for each pair of temporally consecutive events in the journal data 104, compute miles per hour necessary to travel between events given time stamps and locations pertaining to the events. The inference component 214 can additionally contemplate other data when inferring transition between events. For instance, the inference component 214 can receive data from accelerometers such as those in phones and/or laptops, which can be used to detect large accelerations and shut off a hard disk. Such sensor data can be used by the inference component 214 to differentiate between activities such as jogging, sprinting, horseback riding, etc. The inference component 214 can also take into consideration context pertaining to the events 202 and 204. For instance if the user is in the vicinity of a tennis court and if preferences of the user correspond to a particular profile, the inference component 214 can classify the event as playing tennis.

The inference component 214 can additionally consider behaviors of other users in different geographic locations, wherein the other users have interests that are similar to the user. This type of inference can be used in connection with providing recommendations to users.

Inferences generated by the inference component 214 can be stored in the data repository 102 with the journal data 104. Additionally or alternatively, the inference component 214 can provide inferences directly to the display component 110, which can display the events 202 and 204 as journal entries and can further display transition states between events. Of course incorrect inferences generated by the inference component 214 can be manually modified by the user. Thus, the inference component 214 can be used in connection with enriching journal entries generated by the user.

The display component 110 can act as described above in connection with causing the journal data 104 to be displayed in a three-dimensional representation of the geographic region 106. More particularly, the display component 110 can cause the display screen 112 to display journal entries corresponding to the first event 202 and the second event 204 in the three-dimensional representation 114 along with a transition between the journal entries.

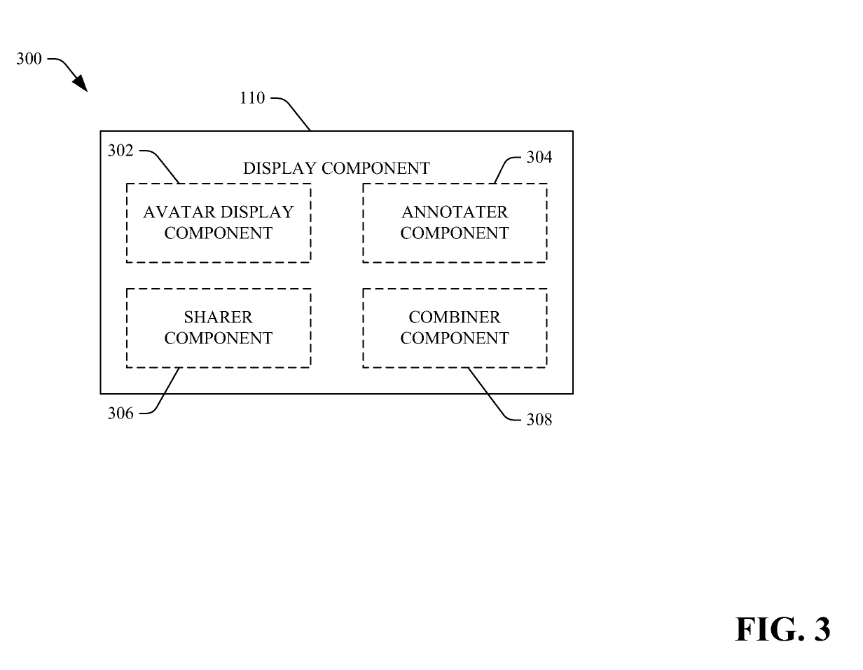

Turning now to FIG. 3, an example depiction 300 of the display component 110 is illustrated. While the depiction 300 illustrates the display component 110 as including a plurality of other components, it is to be understood that the display component 110 may include more or fewer components. Furthermore, the display component 110 need not perform the functionality that is described in connection with each of the components illustrated as being included in the display component 110.

Pursuant to an example, the display component 110 can include an avatar display component 302 that can cause an avatar that is representative of a user to be displayed on the display screen 112 (FIG. 1) in the three-dimensional representation 114 of the geographic region 106. For instance, an avatar generated by the avatar display component 302 can be representative of a user that generates the journal data 104. In another example, an avatar generated by the avatar display component 302 can be representative of a reviewer of journal entries in the three-dimensional representation 114 of the geographic region 106. For instance, the avatar display component 302 can cause an avatar to animate according to common daily activities such as sitting, eating, walking, running, etc. Thus, an avatar can represent real time activities of a user. In another example, an avatar generated by the avatar display component 302 can represent a position of a user at a particular instance in time in the three-dimensional representation 114 of the geographic region 106. The position of the avatar can change in the three-dimensional representation 114 of the geographic region 106 as a reviewer of journal entries temporally “plays back” journal entries of the user, either in real time, fast forward or slow motion.

The display component 110 can additionally include an annotator component 304 that can receive annotation information from the user that causes journal data to be annotated with the annotation information. For instance, an avatar generated by the avatar display component 302 can be animated in accordance with the annotation information. Further, the annotator component 304 can cause a plurality of annotation choices to be presented to the user on the display screen 112, wherein the plurality of annotation choices can include common activities and/or can be dependent upon context of the journal data being annotated. For instance, common activities may include sleeping, working, leisure and sports, household activities, eating and drinking, etc.

Furthermore, user selection of a common activity may cause the annotator component 304 to provide the user with more granular activities. For instance, if the user selects leisure and sports, the annotator component 304 can cause additional annotation choices to be presented such as watch television, socialize, read, play video games, etc. In an example, to initiate the annotator component 304 the user can review journal entries and/or journal data underlying journal entries with respect to a particular time period. For instance, the user can cause an avatar generated by the avatar display component 302 to re-enact activities in the journal data 104 and/or journal entries. When the avatar arrives at an activity that the user wishes to enhance/annotate, the user can initiate the annotator component 304 which can cause a context sensitive menu to be presented to the user, wherein the context sensitive menu includes a plurality of selectable annotation choices. In an example, when the user annotates a journal entry, an action itself is stored in the journal data 104 rather than a particular view provided to the user when the user is annotating the journal entry. Therefore, a reviewer of the journal entry 116 can alter viewing angle, lighting, etc. while an action of the user represented in the journal entry 116 is correctly represented in the three-dimensional representation 114 of the geographic region 106.

The display component 110 can additionally include a sharer component 306 that causes the journal entry 116 to be shared with a second user (e.g., a reviewer). For instance, journal entries of the user may be hosted on a web server and the shared component 306 can receive a request from a reviewer to access the journal entries on the web server. Thus, the reviewer can type a URL pertaining to the journal entries in a web browser. If the reviewer is authorized to review the journal entries (e.g., the reviewer is a contact of the user, the user has explicitly allowed the public in general to review journal entries . . . ), the sharer component 306 can cause the journal entry 116 to be presented to the reviewer in the three-dimensional representation 114 of the geographic region 106. Pursuant to an example, the sharer component 306 can present the journal entry 116 in accordance with viewing preferences of the reviewer. For instance, the reviewer may request to review journal entries that correspond to a particular location or locations. In another example, the reviewer can request to review journal entries that correspond to a particular time period. The share component 306 can filter journal entries in accordance with requests from the reviewer.

Additionally, the share component 306 can cause the journal entry 116 to be displayed in a particular format depending on a device used by the reviewer to view the journal entry 116. For instance, the sharer component 306 can cause the journal entry 116 to be displayed in a first format if the reviewer is using a desktop computer and can cause the journal entry 116 to be displayed in a second format, if the reviewer is using a mobile device. For instance, on a mobile platform the sharer component 306 can cause the journal entry 116 to be displayed in the three-dimensional representation 114 of the geographic region 106 and the reviewer can change viewpoint and lighting pertaining to the journal entry 116. In another example, the sharer component 306 can cause the journal entry 116 to be displayed on a desktop computer by way of a multimedia application using predefined orientation and lighting. Predefined orientation can be inferred, for example, based at least in part upon visibility of an avatar representative of a user and/or reviewer and the three-dimensional representation 114.

With respect to a mobile platform, the sharer component 306 can cause a display in a mobile device to act as a window into a three-dimensional journal entry. For instance, if a reviewer is walking down a particular street the sharer component 306 can cause a display on the mobile device to display a three-dimensional representation of the street from the perspective of the reviewer. A journal entry corresponding to the view shown in the display of the mobile device can be provided to the reviewer. In addition, an avatar can be placed in the three-dimensional representation of the “real world”, and the reviewer can use the avatar as a guide through the streets. In another example, an avatar can be rendered on a real-time captured image of the “real world” in a mobile device, and can be used as a guide.

The sharer component 306 can use position of the reviewer (e.g., GPS) and orientation hardware (e.g., accelerometers, magnetometers . . . ) to align a three-dimensional virtual view with the physical world. Furthermore, when position/orientation hardware is not available, the sharer component 306 may take into consideration optical flow from an imbedded video camera in the mobile device to compute relative motion of the mobile device.

Furthermore, the sharer component 306 can cause a mobile device of the reviewer to notify the reviewer that the reviewer is in relative close proximity to a location that corresponds with the journal entry 116 of the user. For instance, the reviewer may walk past a location that corresponds to an event journaled by the user. The sharer component 306 can cause a cell phone of the reviewer to notify the reviewer of such journaled event and the reviewer's proximity to the event.

The display component 110 can additionally include a combiner component 308 that can cause journal entries of a first user to be displayed on a display screen simultaneously with journal entries of a second user in a three-dimensional representation of a geographic region. More particularly, for example, if the first user and the second user both generate journal entries on a particular date, the first user, the second user and/or a third user can choose to view journal entries of both the first and the second user simultaneously. Pursuant to an example, avatars corresponding to both the first user and the second user can be depicted in the three-dimensional representation of a geographic region pertaining to the journal entries, wherein the avatars can transition in the three-dimensional representation based upon time and location corresponding to journal entries. A reviewer of journal data of multiple users can understand how multiple journal events of different user may relate to one another. For instance, a reviewer simultaneously reviewing the journal data of a first user and a second user can ascertain that such users work proximate to one another and commute at similar times, thereby indicating opportunities for carpooling. While the above examples described simultaneously viewing journal entries of two users, it is understood that journal entries of any suitable number of users can be simultaneously viewed in a three-dimensional representation of a geographic region. Furthermore, the combiner component 308 can take into consideration privacy preferences of users prior to combining journal entries in the three-dimensional representation of a geographic region. For instance, the first user may specify users with whom their journal entries can be combined, may specify which journal entries can be combined with journal events of other users, etc.

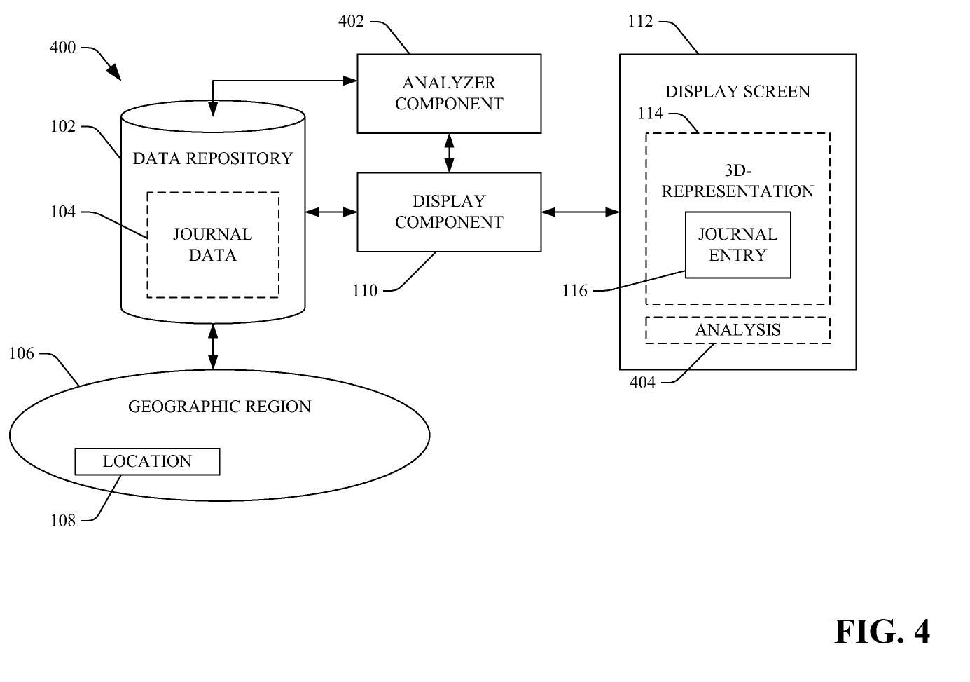

With reference now to FIG. 4, a system 400 that facilitates analyzing journal data is illustrated. The system 400 includes the data repository 102 that comprises the journal data 104. The system 400 can additionally include an analyzer component 402 that can analyze the journal data 104 and can generate an analysis of the journal data 104 responsive to a request from a user. For instance, the analyzer component 402 can determine trends or patterns in the journal data 104. Such trends or patterns can be or include an amount of time that a user undertakes a particular activity over a selected period of time, a number of times that a user has undertaken an activity in a selected period of time, a number of times a user has undertaken a certain activity in a particular geographic region, etc. Still further, the analyzer component 402 can analyze the journal data 104 to detect anomalies for special events in the journal data 104 (e.g., events that deviate from a norm). The analyzer component 402 may then cause the analysis to be stored in the data repository 102 together with the journal data 104 and/or be provided directly to the display component 110. The display component 110 may then cause one or more journal entries corresponding to the journal data 104 to be displayed at appropriate location(s) in the three-dimensional representation 114 (e.g., locations that correspond to the journal data 104). The display component 110 can additionally cause analysis 404 output by the analyzer component 402 to be displayed on the display screen 112. The analysis 404 may then be reviewed by the user.

In another example, analysis output by the analyzer component 402 can be used in a social networking environment. For instance, the analyzer component 402 can determine that the journal data 104 indicates that the user corresponding to the journal data 104 has gone to several concerts of a particular band throughout a geographic region. The analyzer component 402 can also analyze journal data of another user and determine that the other user also travels to watch performances of the same band. The analyzer component 402 can provide such determination to the display component 110 which can inform the user that another user has similar taste in music and is in a substantially similar geographic region. Thus, the analyzer component 402 can recommend activities to the user based at least in part upon interests or activities of other, similar users.

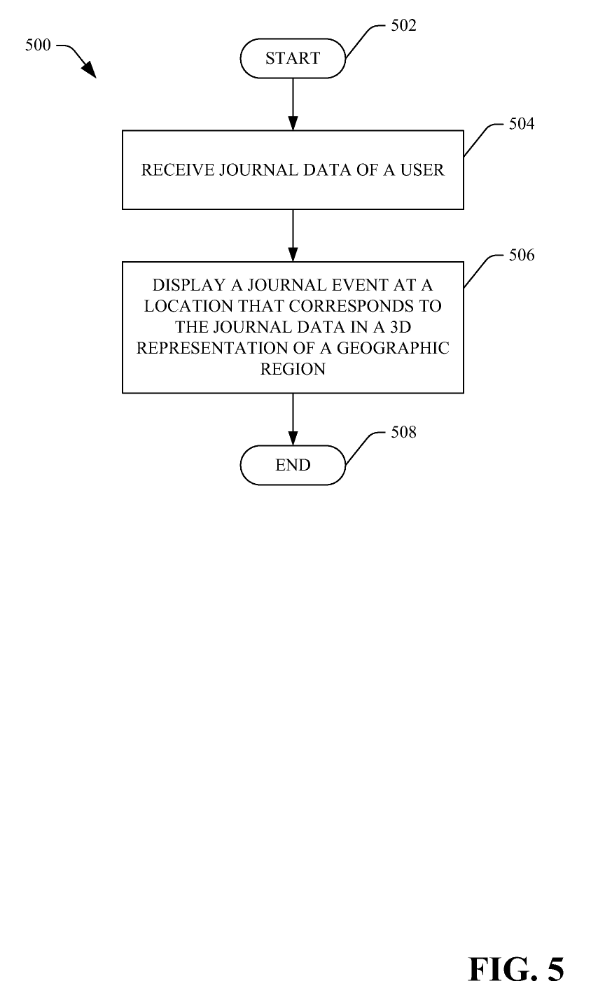

With reference now to FIGS. 5-8, various example methodologies are illustrated and described. While the methodologies are described as being a series of acts that are performed in a sequence, it is to be understood that the methodologies are not limited by the order of the acts in the sequence. In addition, an act may occur concurrently with another act. Furthermore, in some instances not all acts may be required to implement a methodology described herein.

Moreover, the acts described herein may be computer executable instructions that can be implemented by one or more processors and/or stored on a computer readable medium or media. The computer executable instructions may include a routine, a subroutine, programs, a thread of execution and/or the like. Still further, results of acts of the methodologies may be stored in a computer readable medium, displayed on a display device and/or the like.

Referring now specifically to FIG. 5, a methodology 500 that facilitates displaying a journal entry in a three-dimensional environment is illustrated. The methodology 500 begins at 502, and at 504, journal data of a user is received wherein, the journal data can correspond to a location in a geographic region. As noted above the journal data can be or include text, a photograph, a video, audio, a hyperlink or various other types of media. Furthermore, the journal data can include or be associated with data indicating orientation of the journal data, time corresponding to the journal data and/or other information.

At 506, a journal data corresponding to the journal data is displayed on a display screen in a computer implemented three-dimensional representation of the geographic region at the location in the representation that corresponds to the journal data. Thus, for instance, if the journal data is a photograph taken at a particular address on a street, the photograph can be displayed as a journal entry in a three-dimensional representation of the geographic region at the location on the street where the picture was taken. The methodology 500 completes at 508.

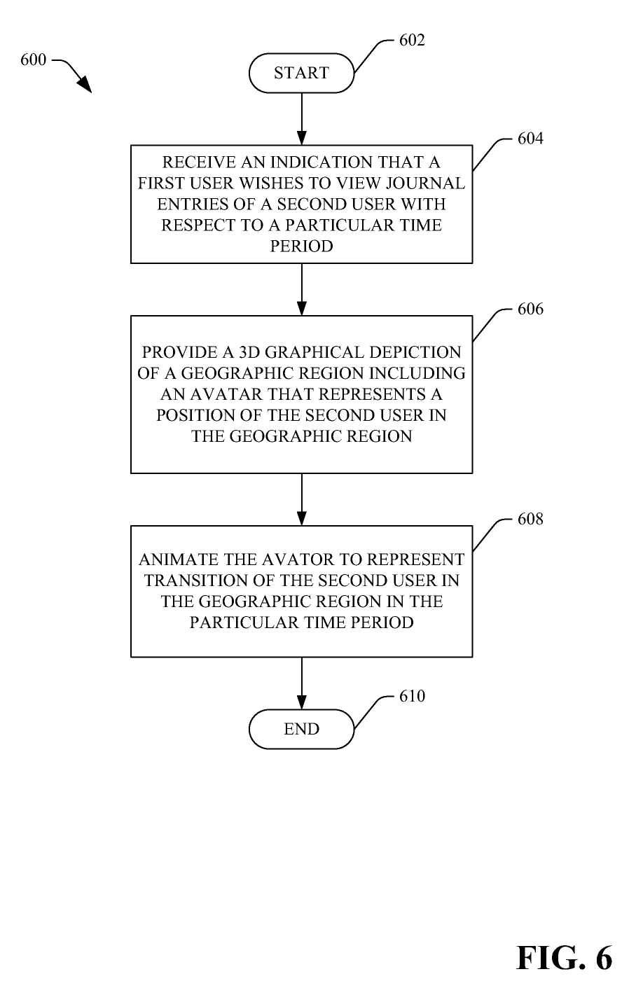

Turning now to FIG. 6, an example methodology 600 for animating an avatar to represent a user is illustrated. At 602, an indication that a first user wishes to view journal entries of a second user with respect to a particular time period is received. For instance, the second user may have a three-dimensional journal that includes multiple journal entries, and the first user may be a contact of the second user that is authorized to review the three-dimensional journal of the second user.

At 606, a three-dimensional graphical depiction of a geographic region is provided, wherein the three-dimensional graphical depiction includes an avatar that is representative of the second user in the geographic region. For instance, the avatar can be positioned at a location in the three-dimensional graphical depiction that corresponds to a location where the second user has a three-dimensional journal entry.

At 608, the avatar is animated to represent a transition of the second user in a geographic region in the particular time period. Thus, the avatar can be animated to change positions to move in the geographic region to represent a particular activity undertaken by the use of the second user, etc. The methodology 600 completes at 610.

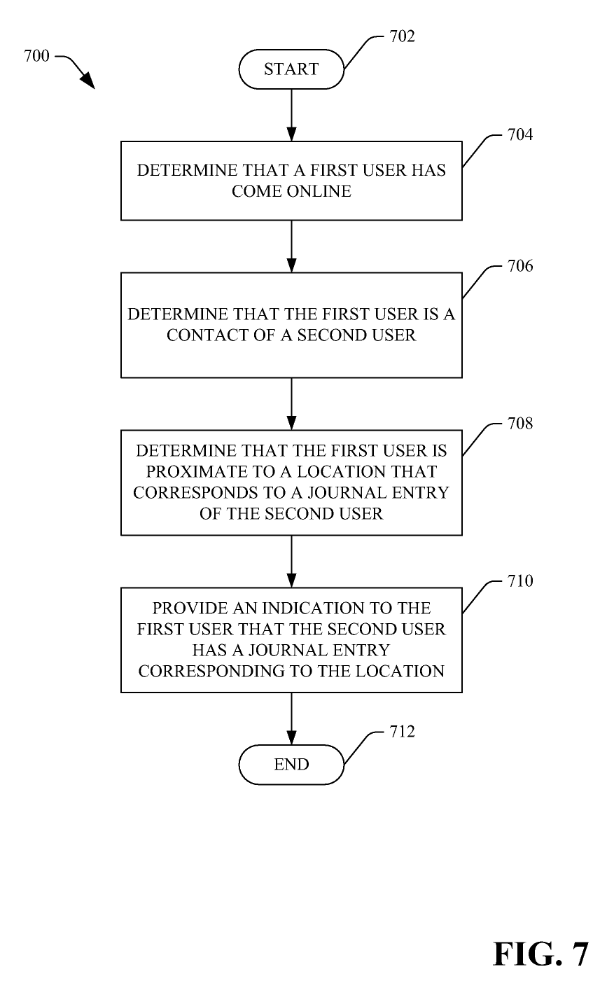

Referring now to FIG. 7, a methodology 700 for providing an indication to a mobile device that an owner of the mobile device is in the vicinity of a journal entry of another user is illustrated. The methodology starts at 702, and at 704 a determination is made that a first user has come online. For instance, the first user can log into a service, can cause a wireless antenna of a mobile device to be activated, etc.

At 706, a determination is made that the first user is a contact of second user, wherein the second user has a three-dimensional journal that includes at least one journal entry. In other words, the second user has caused journal data to be represented as one or more journal entries in a three-dimensional representation of a geographic region. At 708, a determination is made that the first user is proximate to a location that corresponds to a journal entry of the second user. For instance, the second user may have a journal entry that indicates that the second user ate at a particular restaurant. It can be determined that the first user is proximate to such restaurant (e.g., by way of GPS, triangulation, access point analysis, etc.).

At 710, an indication is provided to the first user that the second user has a journal entry corresponding to the location. The indication may be in the form of a text message, in the form of a vibration of a mobile device, a video message, initiation of an application that allows the first user to view journal data of the second user, etc. In another example, a notification can be provided to the first user indicating that the second user was recently at the current location of first user and/or appears to be heading towards the current location of the first user. The methodology 700 completes at 712.

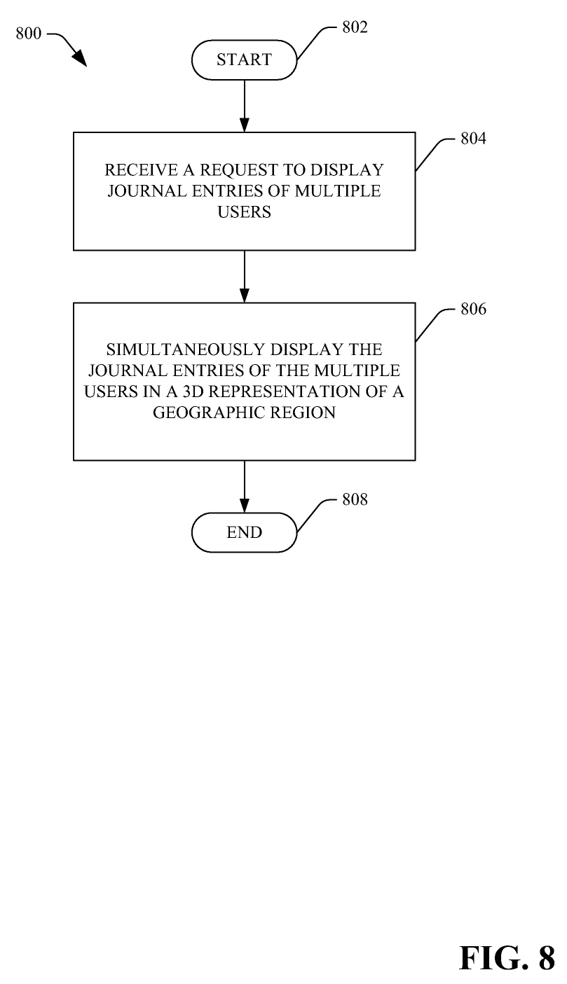

Referring now to FIG. 8, an example methodology 800 for simultaneously displaying journal entries of multiple users in a three-dimensional representation of a geographic region is illustrated.

The methodology 800 starts at 802, and at 804 a request to simultaneously display journal data of multiple users is received. The request can be received from a desktop device, a mobile device, etc. Furthermore, in an example, the request may be to view journal entries of multiple users that are contacts of the requesting party.

At 806, journal entries of the multiple users are simultaneously displayed in the three-dimensional representation of a geographic region. The journal entries of the multiple users, for example, can be displayed in a static fashion such that the three-dimensional representation of the geographic region does not illustrate animated features but rather displays all journal entries of each of the multiple users over a specified time period in the geographic region. In another example, the journal entries of the multiple users can be animated with respect to time. Therefore, the reviewer of the journal entries of the multiple users can ascertain relationships between multiple users and their activities with respect to both location and time. The methodology 800 completes at 808.

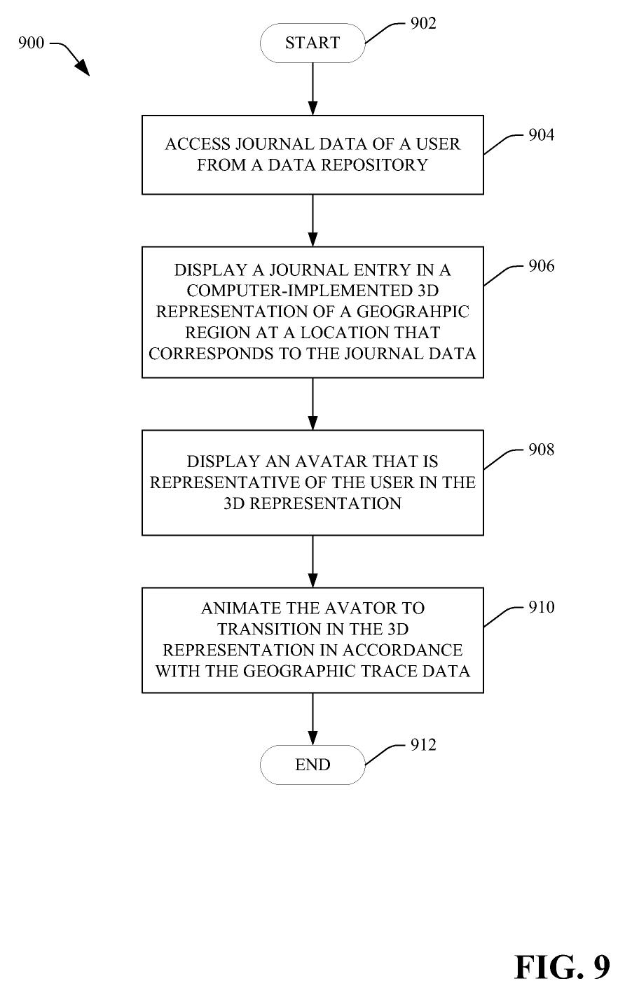

Turning now to FIG. 9, an example methodology 900 for animating an avatar in a three-dimensional representation of a geographic region is illustrated. The methodology starts at 900, and at 902 journal data of a user is accessed from the data repository. For instance, the journal data can correspond to a location in the geographic region and can additionally include geographic trace data. The geographic trace data can be GPS data, data obtained by way of triangulation, data entered manually from the user, data obtained from a mapping application, etc.

At 904, the journal data is displayed as at least one journal entry in a computer implemented three-dimensional representation of the geographic region at the location that corresponds to the journal data. Thus, if the journal data is a photograph taken by the user at a particular address on a certain street, such journal data can be displayed as a journal entry in a three-dimensional representation of the geographic region at the address and street in the representation that corresponds to the address and street where the picture was taken.

At 906, an avatar is displayed that is representative of the user in the three-dimensional representation of the geographic region. At 908, the avatar is animated to transition in the three-dimensional representation of the geographic region in accordance with the geographic trace data. Thus, a reviewer of the three-dimensional journal of the user can observe a representation of the user's activities over a defined period of time. The methodology 900 completes at 910.

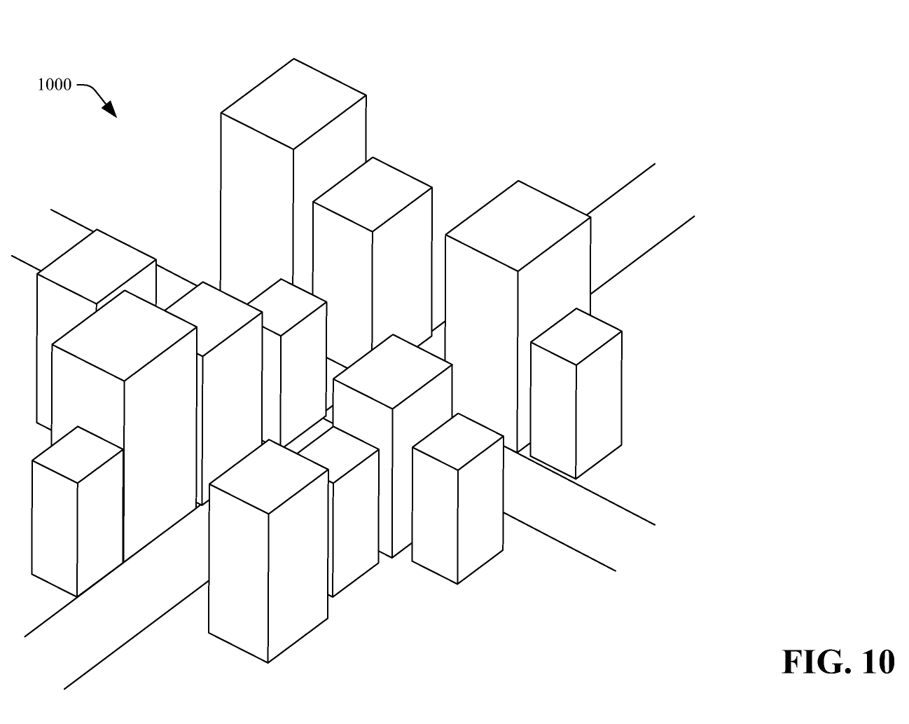

Referring now to FIG. 10, an example of a three-dimensional representation 1000 of a geographic region is illustrated. As has been described above, journal entries can be displayed in the three-dimensional representation 1000 based at least in part upon location data corresponding to underlying journal data. Furthermore, a reviewer of the three-dimensional representation (which includes at least one journal entry) can cause orientation with respect to viewing perspective of the reviewer to be altered. Furthermore, a reviewer can zoom in or zoom out of the example three-dimensional representation 1000 to particular geographic regions and can further search for journal entries in the three-dimensional representation 1000 based at least in part on the time period corresponding to the journal entries.

While the example three-dimensional representation 1000 is shown as being a plurality of buildings around two intersecting streets, it is to be understood that the three-dimensional representation can be any suitable representation of a geographic region. For instance, as will be shown herein, a three-dimensional representation can be a representation of a single building, representation of the interior of a home or any other suitable representation of a real life geographic location.

Furthermore, the perspective of a reviewer of the journal entries (which can be a user that owns the journal data, a contact of the user that is reviewing journal entries, or other third party) can be automatically determined based on reviewing requests of a reviewer. For instance, if a reviewer wishes to review journal entries based upon a particular period of time the perspective of the three-dimensional representation 1000 can alter such that the subset of the geographic region is depicted wherein, journal entries corresponding to the specified time period correspond to the subset of the geographic representation.

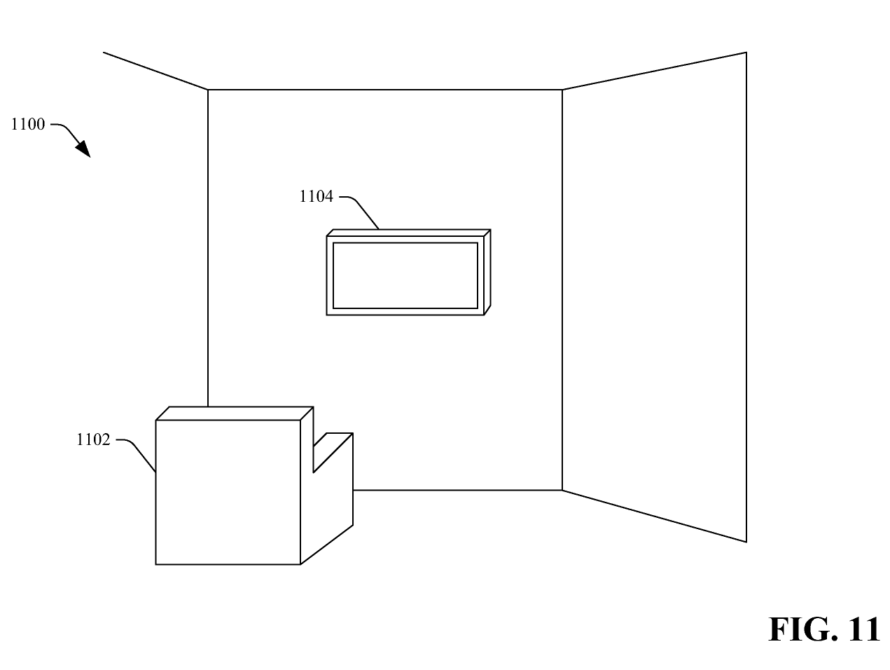

Now referring to FIG. 11, an example three-dimensional representation 1100 of an inside of a building, such as a three-dimensional representation of a room, is illustrated. The example three-dimensional representation 1100 includes a representation of a chair 1102 and a representation of a television 1104. As described above, an avatar can be animated in the three-dimensional representation 1100. For instance, the avatar can be animated to represent that the user sits in a chair 1102 and watches the television 1104. Furthermore, the inference component described above can infer that, based upon geographic information, the user was sitting in the chair 1102 and watching the television 1104.

With reference to both FIGS. 10 and 11, these three-dimensional representations can be obtained from any suitable source. For instance, many available mapping applications include three-dimensional representations of particular geographic regions. In addition, a user may create a graphical representation of the geographic region by way of, for instance, software used in connection with creating second life geographic regions. Still further, a combination of existing three-dimensional representation and user created three-dimensional representations can be employed in connection with three-dimensional journaling.

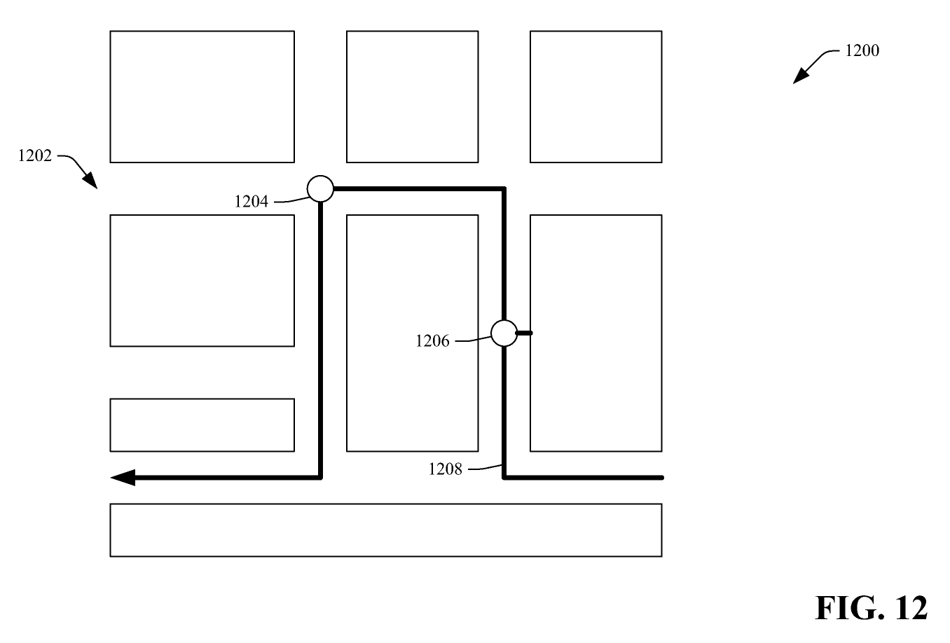

With reference now to FIG. 12, an example depiction 1200 of a geographic trace through a geographic region 1202 is illustrated. While the geographic region 1202 is shown to be two-dimensional, it is understood that a perspective can change such that the geographic region 1202 is shown in a three-dimensional manner.

A user can have two journal entries 1204 and 1206 in the geographic region 1202. For instance, the journal entries may include photographs, textual entries describing a location, video of a location, etc. In addition, geographic trace data 1208 indicates travels of the user through the geographic region 1202. A reviewer of such a three-dimensional journal can select or be provided with data pertaining to the journal entries 1204 and 1206 such that the reviewer can view pictures, videos, audio, etc. In addition, a reviewer can cause the journal entries to “play back” over a particular time period. Therefore, a reviewer can watch travels of the user through the geographic region 1202.

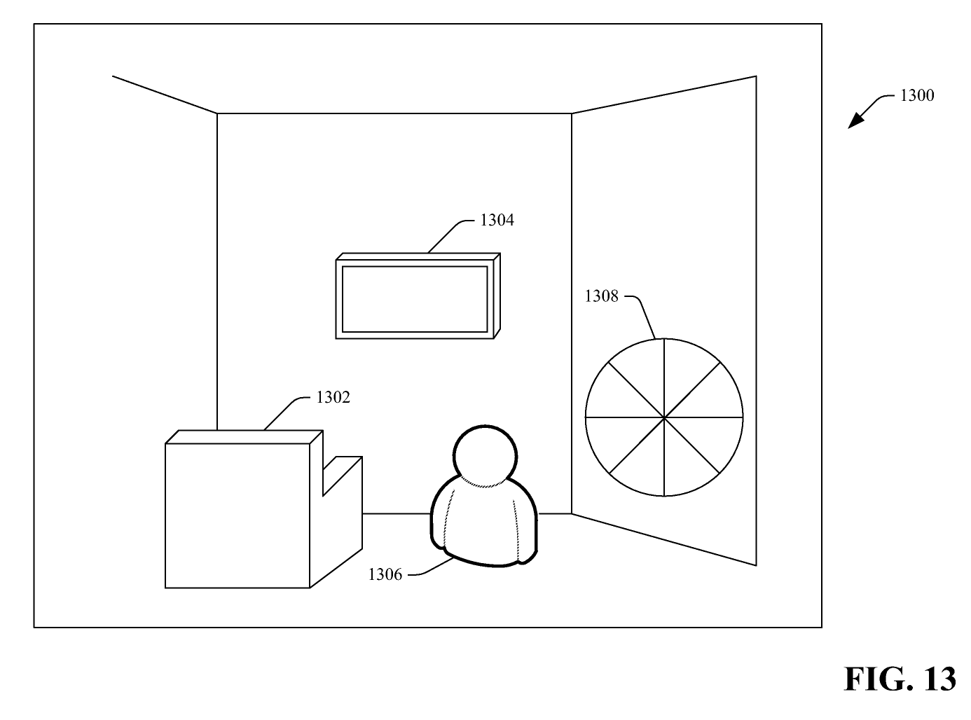

Turning now to FIG. 13, an example graphical user interface 1300 is illustrated. The graphical user interface 1300 includes a three-dimensional representation of the inside of a room, wherein the room includes a chair 1302 and a television 1304 mounted on a wall of the room. Also depicted is an avatar 1306 that can represent a user that corresponds to the three-dimensional journal. Additionally, the graphical user interface 1300 includes a plurality of selectable annotation choices 1308. For instance, the user can select an annotation choice from the plurality of annotation choices 1308 to describe current activity of the user. While the annotation choices 1308 are shown as being selectable by way of a pie-shaped graphical interface, it is to be understood that other graphical icons or tools can be used in connection with selecting an annotation choice, such as a drop-down menu, buttons, etc. The avatar 1306 may then act in a manner that is representative of the selected annotation choice. For instance, one of the plurality of annotation choices 1308 may be watching television 1304. The user can select such annotation choice and the avatar 1306 can be positioned on the chair 1302 facing the television 1304, thereby representing an activity of the user in real-time.

Furthermore, at least one of the plurality of annotation choices 1308 can include one or more sub-choices. For instance, one of the annotation choices 1308 may be “leisure activity”. Upon selection of such choice, a plurality of more specific annotation choices can be presented to the user such as watching television, reading a book, etc.

In an example, the three-dimensional representation that includes the avatar 1306 annotated in accordance with the user's selection of one of the plurality of annotation choices 1308 can be available to other viewers to view in real-time. Thus, the contacts of the user can access a three-dimensional journal of the user and determine activity of the user at a current point in time. In another example, annotation choices selected by the user can be stored with a corresponding time stamp. A reviewer of the three-dimensional journal can watch previous activities of the user by “playing back” activities of the user. Still further, the user can annotate previous activities, such that an avatar represents activities of the user in the past.

Furthermore, in accordance with what has been described above, use of a three-dimensional representation of a geographic region allows a reviewer to view several journal entries at a substantially similar point in time that correspond to a substantially similar geographic region. It may be desirable to filter some information, as providing the reviewer may be provided with too much information. Such filtering can be undertaken based at least in part upon proximity to authors of journal entries at a particular point in time, proximity in time of journal entries, profiling of authors with respect to the reviewer (e.g., which authors have interests most similar to the reviewer), amongst other data.

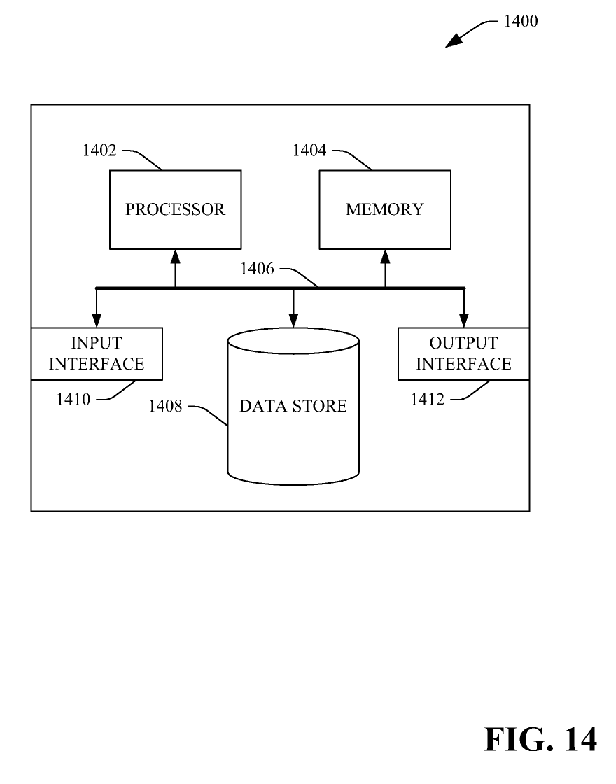

Now referring to FIG. 14, a high level illustration of an example computing device 1400 that can be used in accordance with the systems and methodologies described herein is illustrated. For instance the computing device 1400 may be used in a system that supports three-dimensional journaling; wherein three-dimensional journaling encompasses both inputting journal data and reviewing journal data. In another example, at least a portion of the computing device 1400 may be used in a system that supports notifying a reviewer of journal data when they are proximate to a journaled event of a first user. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store three-dimensional representations of geographic regions, journal data, user preferences, user contact information, etc.

The computing device 1400 additionally includes a data store 1408 that is accessible by the processor 1402 by way of the system bus 1406. The data store 1408 may include executable instructions, journal data, three-dimensional representations of geographic regions, user contact information, etc. The computing device 1400 also includes an input interface 1410 that allows external devices to communicate with the computing device 1400. For instance, the input interface 1410 may be used to receive instructions from an external computer device, from a mobile device, from a user, etc. The computing device 1400 also includes an output interface 1412 that interfaces the computing device 1400 with one or more external devices. For example, the computing device 1400 may display text, images, three-dimensional representations, journal data, etc. by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A three-dimensional journaling system, comprising:
a data repository that comprises journal data of a user, wherein the journal data corresponds to at least one location in a geographic region; and
a display component that causes at least a portion of the journal data to be displayed on a display screen as a journal entry in a computer-implemented three-dimensional representation of the geographic region at the location in the three-dimensional representation that corresponds to the location in the geographic region.

2. The system of claim 1, wherein the journal data includes at least one of location data, a picture, a video, text, or a hyperlink.

3. The system of claim 1, wherein the location data includes a Global Positioning System trace.

4. The system of claim 1, wherein the journal data comprises a first event that corresponds to a first location and a first time and a second event that corresponds to a second location and a second time, and further comprising an inference component that infers a transition between the first event and the second event based at least in part upon the first location, the first time, the second location, and the second time.

5. The system of claim 1, further comprising an avatar display component that causes an avatar that is representative of the user to be displayed on the display screen in the 3-dimensional representation of geographic region at the location that corresponds to the journal data.

6. The system of claim 5, wherein the avatar display component causes the avatar to be animated to represent an activity of the user that is included in the journal data.

7. The system of claim 6, further comprising an annotator component that receives annotation information from the user and causes the journal entry data to be annotated with the annotation information, wherein the displayed avatar is caused to be animated in accordance with the annotation information.

8. The system of claim 7, wherein the annotator component causes the display screen to display a plurality of selectable annotation choices, wherein selection of an annotation choice causes the avatar to be animated.

9. The system of claim 1, further comprising a sharer component that causes the journal entry to be shared with a second user.

10. The system of claim 9, wherein the sharer component causes a mobile device of the second user to notify the second user that the second user is proximate to the location that corresponds to the journal data.

11. The system of claim 1, further comprising a combiner component that causes the journal entry of the user to be displayed on the display screen simultaneously with a journal entry of a second user.

12. The system of claim 1, further comprising an analyzer component that analyzes the journal data and outputs analysis pertaining to the journal data responsive to a request from the user.

13. The system of claim 1, wherein the display component causes the journal entry to be displayed on a mobile device.

14. A method comprising the following computer-executable acts:
receiving journal data of a user, wherein the journal data corresponds to a location in a geographic region; and
displaying, on a display screen, a journal entry that is based upon the journal data in a computer-implemented three-dimensional representation of the geographic region at the location in representation that corresponds to the journal data.

15. The method of claim 14, wherein the journal data is received from a mobile device.

16. The method of claim 14, further comprising:
displaying an avatar that is representative of the user at the location in the representation of the geographic region; and
animating the avatar to cause the avatar to transition through the representation of the geographic region in accordance with actions of the user.

17. The method of claim 14, further comprising:
simultaneously displaying journal entries from a plurality of users in the three-dimensional representation.

18. The method of claim 17, further comprising simultaneously animating a plurality of avatars in the three-dimensional representation, wherein the plurality of avatars are representative of the plurality of users.

19. The method of claim 14, further comprising transmitting a notification to a second user when the second user is proximate to the location that corresponds to the journal data.

20. A computer-readable medium comprising instructions that, when executed by a processor, perform the following acts:
access journal data of a user from a data repository, wherein the journal data corresponds to a location in a geographic region and includes geographic trace data;
display a journal entry based upon the journal data in a computer-implemented three-dimensional representation of the geographic region at the location that corresponds to the journal data;
display an avatar that is representative of the user in the representation of the geographic region; and
animate the avatar to transition in the representation of the geographic region in accordance with the geographic trace data.
